(19) United States
(12) Patent Application Publication
(10) Pub. No.: US 2025/0311031 A1
(43) Pub. Date: Oct. 2, 2025

(54) SYSTEMS, METHODS, AND DEVICES FOR PAIRING DEVICES WITHIN A HOSPITALITY ENVIRONMENT

(71) Applicant: Sonifi Solutions, Inc., Sioux Falls, SD (US)

(72) Inventors: Joshua H. Pulford, Sioux Falls, SD (US); Kara Heermans, Beresford, SD (US); Darin Johnson, Sioux Falls, SD (US); Eric Aasen, Sioux Falls, SD (US)

(73) Assignee: Sonifi Solutions, Inc., Sioux Falls, SD (US)

(21) Appl. No.: 19/091,535

(22) Filed: Mar. 26, 2025

Related U.S. Application Data
(60) Provisional application No. 63/570,672, filed on Mar. 27, 2024.

(51) Int. Cl. H04W 76/14; G06K 7/14

(52) U.S. Cl. CPC H04W 76/14; G06K 7/1417

(57) ABSTRACT

A server may generate a unique identifier based on a request from an output device to pair a user device with the output device, send a first message comprising the unique identifier to the output device, receive, from the user device, a second message comprising the unique identifier, and generate and send a third message to the output device that enables the output device to pair with the user device such that the user device is enabled to control the output device over a local area network.

### CROSS REFERENCE TO RELATED APPLICATIONS

This application claims the benefit of U.S. Provisional Patent Application Ser. No. 63/570,672, filed Mar. 27, 2024, the entire disclosure of which is hereby incorporated herein by reference for all that it teaches and for all purposes.

### FIELD

Example embodiments are generally directed to devices, systems, and methods for pairing (e.g., direct pairing) between devices in a network within a hospitality environment.

### BACKGROUND

In a hospitality environment, such as a hospital or hotel, the property manager or operator may provide audio and/or visual entertainment to individual rooms through corresponding displays (televisions, tablets, etc.) in each room. A user may be provided with the ability to select and/or control the entertainment on the device within the room through their smartphone or other personal computing device.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 illustrates a system according to at least one example embodiment.

FIG. 2 illustrates an environment for the system in FIG. 1 according to at least one example embodiment.

FIG. 3 illustrates an example message diagram for the system and environment if FIGS. 1 and 2 according to at least one example embodiment.

FIG. 4 illustrates a method according to at least one example embodiment.

### DETAILED DESCRIPTION

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

Additional features and advantages of embodiments of the present disclosure will become more readily apparent from the following description, particularly when taken together with the company drawings.

Related art systems for providing and controlling entertainment within a hospitality environment rely on direct pairing between a user device (e.g., a smartphone, personal computer (PC), tablet, etc.) and an output device (e.g., a television, tablet, PC, etc.) to be controlled to provide the content. For example, a user device and a physical streaming device at a television may connect to one another according to known methods (e.g., over Wi-Fi using a Service Set Identifier (SSID) of the streaming device) to enable the user device to control the streaming device and, thus, the content (video) and aspects of the content (e.g., volume) at the television. However, the property manager (e.g., hotel or hospital management) has no control or oversight over the pairing process and the subsequent connection between the two devices. As a result, such connection between the output device and user device may not be secure and the content cannot be managed by the property manager. Other related art systems involve a backend on-site or off-site server in the pairing process, and once the user device and output device are paired, control commands from the user device flow from the user device through the server to the output device. These server-involved systems enable the property manager to have control and oversight of the content being provided to the output device, but require network resources to provide content and control functions to the user device.

Inventive concepts propose to provide the resource-saving advantages of a direct pairing system with the control, security, and oversight advantages of a server-involved system. For example, at least one embodiment is directed to a system that equips an output device with a dynamic firewall. The dynamic firewall may be implemented by enabling a whitelist at the output device to be dynamic. For example, a whitelist may be stored at an output device, such as at a Set Top Box (STB) or similar module connected to the output device such as a television. The whitelist may contain an updatable directory of trusted entities (e.g., user devices) that are allowed to connect to and control the output device. The whitelist may be updated in real-time to add and remove user devices to/from the whitelist under control of an on-site or off-site server (e.g., a cloud server). Adding user devices to the whitelist may occur through a pairing process under control of the server and that involves the user device, the server, and the output device. Removal of user devices from the whitelist may also be under control of the server, and may occur in response to certain triggers, such as the end of a user's stay at a hotel. Compared to the related art, a system according to example embodiments may, among other things, enable oversight and control over content provided to users, have a more simplified system architecture, and/or utilize fewer network resources while still providing a seamless experience for the user. Systems according to example embodiments may avoid the use of third party management authorities typically used to broker isolation between devices in a hospitality or commercial environment.

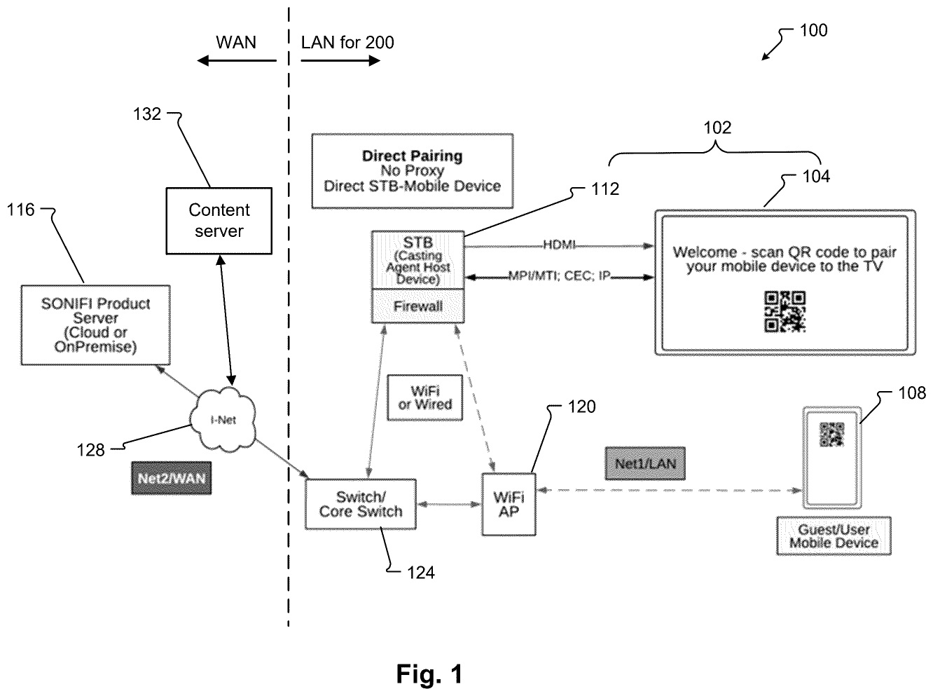

Example embodiments will now be described with reference to FIG. 1, which shows a system 100 that includes a display 104 (referred to in some examples as a TV 104) and a user device 108. The display 104 may comprise suitable hardware and software and processing capability for reproducing audio and/or video content for consumption by a user. For example, a display 104 may be implemented by a television (LED, LCD, etc.), a computer monitor, a tablet, a projector, and/or other device suitable for reproducing audio and/or video content. A user device 108 may correspond to a device that has computing and storage capabilities and that is generally, although not necessarily, mobile in nature. Accordingly, the user device 108 may be implemented with a smartphone, a laptop, a tablet, and/or the like.

The display 104 may include (e.g., be physically integrated with) or be connected to (but physically separate from) a casting agent host device or endpoint device 112, such as a STB, a proprietary streaming device (e.g., an over the top (OTT) device such as a Chromecast®), or similar endpoint device or module for handling casting functions and content traffic on behalf of the display 104. The endpoint device 112 may comprise suitable hardware and software and processing capability for providing a communications interface between display 104 and a switch 124 and/or a router 120 (also called access point AP). FIG. 1 shows an example that involves an STB 112, which as shown, may be configured with a firewall, such as a dynamically controlled or updatable whitelist containing identifiers of user devices 108 that are authorized to control an output device 102, such as content provided to the display 104 and/or display 104 itself. The combination of the display 104 and the endpoint device 112 may form the output device 102.

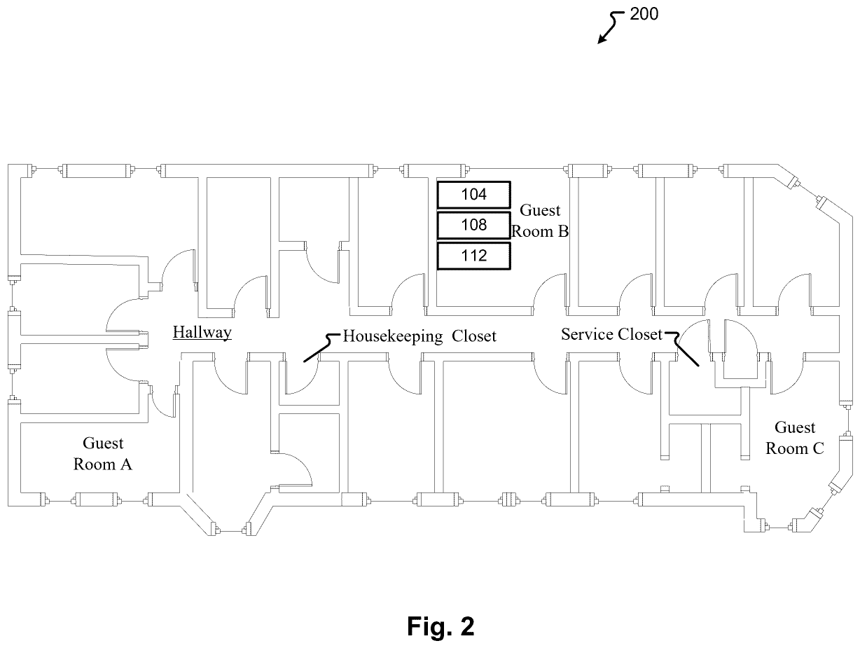

The system 100 may provide entertainment services to an environment 200 illustrated in FIG. 2. The environment 200 may correspond to hospitality location (hotel, motel, inn, etc.) or healthcare facility (acute care hospital, clinic, etc.) that includes a plurality of guest or patient rooms A, B, C, etc. and other service related rooms. In this scenario, each guestroom in the environment 200 may include a display 104, a user device 108 when occupied by a guest, and an endpoint device 112, as shown for guest room B, for example. A guestroom may further comprise a router 120 and/or a switch 124 in some embodiments. In at least one embodiment, on-site routers 120 and/or switches 124 are located in service closets or other areas of the environment 200 not easily accessible to guests.

Referring back to FIG. 1, the system 100 may further include a server 116. In general, the server 116 is used for pairing a user device 108 to an output device 102 to enable the user device 108 to cast content to and control content cast to the output device 102. The server 116 may include suitable hardware and software and processing capability for controlling various functions within the system 100. In one embodiment, the server 116 provides and controls access to entertainment options for users within the system 100. Such entertainment options include but are not limited to viewing of live television programming, video on demand, room service, video games, and/or the like, all of which may be presented on the display 104. Thus, the server 116 may be installed and/or controlled by an entity that enables the entertainment options and controls user access to such options.

In one example, the server 116 comprises a collection of servers. Additionally or alternatively, the server 116 may comprise one or more network switches (e.g., Ethernet switches) to route signals. The server 116 may be cloud-based and remote from the other elements of the system 100 or on-site and local to the other elements of the system 100 (or partially on-site and partially remote). For example, in one configuration, the server 116 is deployed remotely from the environment 200 so that the server 116 may remotely control multiple environments 200 from a single location (e.g., in accordance with suitable cloud computing technologies). Here, troubleshooting and maintenance of a remotely located server 116 can occur at the single, remote location of the server 116. In another configuration, the server 116 is deployed local to the environment 200, such as within a service closet of the environment 200 or some other suitable location near or on-site the environment 200. In this case, a server 116 may be located at each one of multiple environments 200. In yet another example, a server 116 may have some components located local to the environment 200 and some components located remote to the environment 200.

The server 116 can include or have access to content, such as stored movies, videos, menu screens, animations, audio content, and/or the like. The server 116 may access content through a third party content server 132 (e.g., through a streaming application). In addition, the server 116 includes one or more processors for executing instructions implementing features of the supported systems, video encoders or cards, and a connection to a property content distribution network. The content distribution network interconnects the server 116 to the displays 104 or other devices throughout the environment 200 and may comprise router(s) 120, endpoint devices 112, switches 124, and/or user devices 108.

The system 100 also includes a content server 132 that provides content (audio and/or video) to the STB 112 and display 104 and/or the user device 108. In some cases, the content server 132 is managed by subscription-style streaming service that streams content to authorized users.

Communication between the elements of the system 100 may occur over different types of networks, such as network Net1 (e.g., a local area network (LAN)) and network Net2 (e.g., a wide area network (WAN)), that utilize one or more routers 120, one or more switches 124, and/or the Internet 128. The one or more routers 120 may comprise suitable hardware and software and processing capability for providing communication between the user device 108, the endpoint device 112, the one or more switches 124, the Internet 128, and/or the server 116. A router 120 may be wireless in nature (e.g., embodied by a Wi-Fi access point (AP) in FIG. 1) and enable wireless communication between elements of the system 100. A switch 124 may enable wired communication between elements of the system 100. For example, a switch 124 may comprise an RF router for routing signals encoded with frequency-shift keying (FSK) techniques and/or a network switch, such as an Ethernet switch, and/or the like. One or more routers 120 and/or switches 124 may exist within the environment 200 while one or more other routers 120 and/or switches 124 are remote to the environment 200 to communicate signals over long distances. As such, the networks Net1 and Net2 may comprise wired and/or wireless connections between elements.

In some cases, a switch 124 acts as an edge device to control traffic between the local area network (Net1) that comprises the output device 102 and a wide area network (Net2) that comprises elements outside of the environment 200, such as the server 116 and/or the content server 132. As may be appreciated, the local area network (Net1) is managed or manageable by an entity, such as an operator of the environment 200, while elements within the wide area network (Net2) are not necessarily managed or manageable by the entity. Stated another way, the operator of the environment 200 may have the ability to exert control over communications between elements within the LAN (Net1) but have no control or less control over communications between elements within the WAN (Net2). Notably, the operator of the environment 200 may control and operate the server 116, which is shown in FIG. 1 as being part of the WAN but may also be located within the LAN of environment 200.

Although not explicitly illustrated, the network Net1 and/or the network Net2 may be at least partially implemented with wireless cellular technology (e.g., 4G, LTE, 5G, etc.). In one non-limiting scenario, user device 108 may send and receive the various messages described herein over a wireless cellular network. For example, the user device 108 may send and receive messages to/from servers 116 and/or 132 over a cellular network, with any message from the user device 108 that is destined for the output device 102 being sent over the cellular network to the servers 116 and/or 132 which forward the message to the output device 102 through the Internet 128 and routers 120 and/or switches 124.

Communication between elements of the system 100 may also have various configurations. For example, the router(s) 120, server 116, and/or switch(es) 124 may communicate with one another over a closed or private network that does not involve the internet such as a LAN (local area network) or WAN (wide area network) connection. In other embodiments, the Internet 128 facilitates communication between the routers 120, server 116, and/or the switch(es) 124. The LAN may include wired connections (see solid lines) and wireless connections (dashed lines).

It should be appreciated that the elements of the system 100 and environment 200 are shown for the sake of explanation and that more or fewer elements may be included. In addition, one or more elements of the system 100 may be integrated with one or more other elements of the system 100.

It should further be appreciated that various elements in FIG. 1 (e.g., items 104, 108, 112, 116, 120, 124, 132) and other figures may be implemented with or include suitable processing circuitry. Such processing circuitry may comprise hardware or software and hardware. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry 128.

In operation of the system 100, a user connects the user device 108 to a property's (e.g., hotel) Wi-Fi through network Net1. Then, the user may select through a remote (not shown) of the TV 104 an option displayed on the TV 104 to use the property's casting service or content providing service (step 302). In response to the user's selection of the option, the STB 112 sends a request (request message) in step 304 to the server 116 over networks Net1 and Net2 that informs the server 116 that a user would like to pair their user device 108 to this particular output device 102. The request to the server 116 may include information that allows the server 116 to distinguish the STB 112 and/or TV 104 from other STBs and TVs on the property and other STBs and TVs at other properties controlled by the server 116. Such information may include an identifier of the property, an Internet Protocol (IP) address of the STB 112 and/or the TV 104, a unique identifier associated with the STB 112 and/or the TV 104, and/or other suitable information that the server 116 may use to identify and send a communication back to the requesting STB/TV.

In response to receiving the request and using information in the request, the server 116 identifies the requesting STB/TV's location (e.g., the property site and room number, the STB's IP address, and/or the like) and generates a unique identifier, such as a randomly generated access code (for example, a random six digit number), a QR code, or other suitable identifier or code, to the STB/TV in step 306. The unique identifier generated by the server 116 may be unique within the server 116 itself for at least some period of time. That is, the unique identifier generated by the server 116 should remain distinguishable from other identifiers generated by the server 116 for the same pairing purpose for some period of time, but not necessarily at all times. Stated another way, the server 116 may reuse a previously generated unique identifier so long as that unique identifier is not currently in use for another pairing process that would cause confusion at the server 116 as to which output device 102 has sent the request to pair with a user device 108. After generating the unique ID, the server 116 sends a message comprising the ID (unique ID message) to the STB 112 in step 308.

In step 310, the TV 104 then displays the unique identifier as a prompt for the user to enter the unique identifier into the user device 108. The method by which the unique identifier is entered into the user device 108 in step 311 depends on the type of identifier provided. For example, if the unique identifier corresponds to a sequence of random numbers displayed on the TV 104, then the user may enter the sequence of numbers into a corresponding application or open webpage that the user has been instructed to open on the user device 108 as part of the prompt displayed on the TV 104. FIG. 1 shows an example where the unique identifier corresponds to a scannable code (QR code), in which case the user device 108 may scan the code with a built-in camera. In this example, the scanning the code with the camera may prompt the user to open a URL on the user device 108, which when opened, requests the user to input user-specific information, such as name, room number, loyalty number, and/or the like. Notably, the same user-specific information may also be required for other implementations of the unique identifier, where such information is able to be entered via an application running on the user device 108.

Upon entry of the user-specific information, the user device 108 sends a message (pairing message) in step 312 to the server 116 over networks Net1 and Net2 to fulfill the user device's 108 role in the pairing process. Such a pairing message may include the user-specific information and/or other information that enables the server 116 to authenticate the user device 108 in step 314 as a device that should be allowed to control content displayed on the TV 104. Such other information may include the unique identifier itself (e.g., the sequence of numbers displayed on the TV) or information associated with the unique identifier (e.g., information derived directly from or unique to the scannable code).

Thereafter, in step 316, the server 116 sends a message (whitelist message) to the STB 112 over networks Net1 and Net2 that informs the STB 112 that the user device 108 is an authorized and authenticated device that should be allowed to connect to and control the STB 112 and/or TV 104. Such a message may include information specific to the user device 108, such as the IP address of the user device 108, a phone number of the user device 108, or other suitable information about the user device 108 that the STB 112 then adds to the firewall's whitelist at the STB 112 so that the STB 112 can continually check whether commands from the user device 108 should be allowed to control the STB 112 and/or TV 104 (step 318). After the STB 112 adds the user device 108 to the whitelist (e.g., by updating the firewall whitelist with the IP address of the user device 108), the STB 112 may send a message (success message) to the server 116 over networks Net1 and Net2 to inform the server 116 that the pairing process between the user device 108 and the STB 112/TV 104 is complete (step 320). Optionally, in step 324, in response to receiving the success message in step 320, the server 116 sends a corresponding success message in step 324 to the user device 108 to inform the user that this device is now ready to control or cast content at the STB 112 and display 104.

With the user device 108 now paired to the output device 102, the user may use the user device 108 to cast content to and/or control the STB 112 and/or the TV 104. For example, as illustrated with command/response messages in step 328, the STB 112, now with the user device's 108 IP address added to the firewall whitelist, may be enabled to handle DNS traffic and respond to multicast DNS (mDNS) transmissions (e.g., commands such as channel change, volume change, input selection) from the user device 108 with unicast transmissions (e.g., responses to commands) back to the user device 108. Meanwhile, the user device 108 knows that casting is available due to continuous broadcasts by the STB 112 that indicate casting is available. As may be appreciated, a successful pairing between a user device 108 and an output device 102 enables command and control signals from the user device 108 to travel to the output device 102 without intervention by the server 116. However, the command and control signals from the user device 108 to the output device 102 may flow through LAN elements, such as the router 120 and/or switch 124. Thus, upon successful pairing, direct communication between the user device 108 and the output device 102 may involve certain LAN elements, such as the router 120 and switch 124, while excluding WAN elements, such as the server 116 and the Internet.

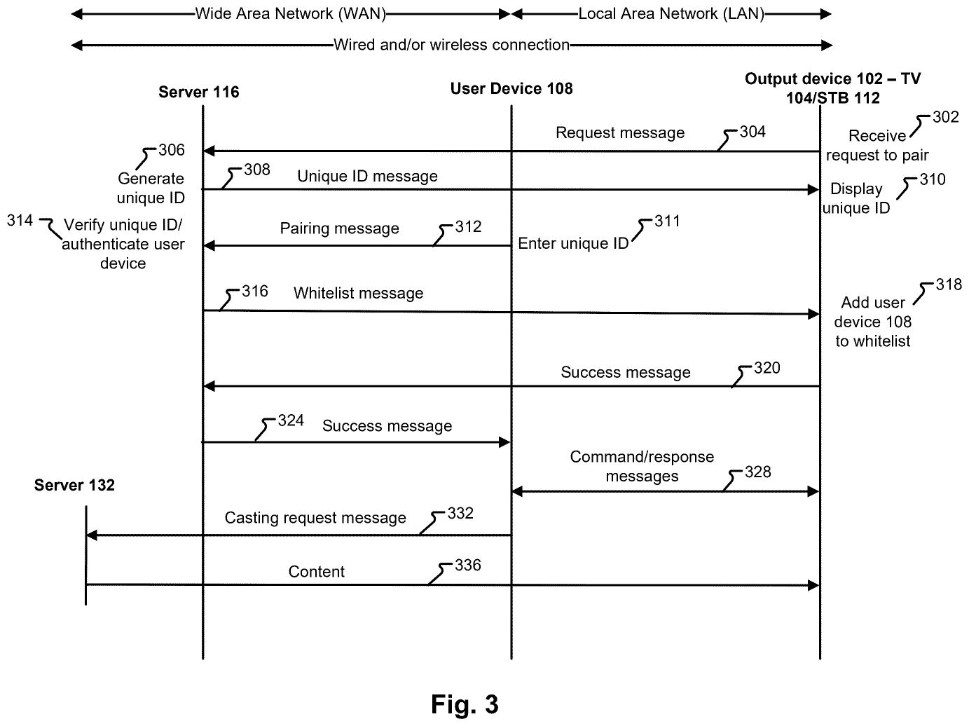

In accordance with casting technology, the user may select an application stored on the user device 108 from which the user wishes to obtain content. If not previously completed, the opened application may request the user's subscription credentials (e.g., username and password), which are sent from the user device 108 to the content server 132 through networks Net1 and Net2 for authentication by the content server 132. The user may then use the application on the user device 108 to select content for casting to the STB 112/TV 104. At some point during the pairing process or afterward, the user device 108 obtains an address (e.g., an IP address) of the STB 112, and this address of the STB 112 is sent by the user device 108 to the content server 132 in a message along with the subscription credentials and/or the user's selection of the content within the application. FIG. 3 shows an example where these tasks are carried out at step 332 by sending a casting request message from the user device 108 to content server 132. The content server 132 then uses the STB 112 address to send the selected content to the correct STB 112 in step 336. Thereafter, the content may be controlled (paused, fast-forwarded, re-winded, etc.) at the STB 112 and display 104 through a command from the user device 108 to the content server 132 that is then reflected at the STB 112 and 104 upon the content server 132 adjusting the content in accordance with the received command. Notably, commands related to control of casting content from content server 132 do not necessarily flow through the server 116. However, it should be appreciated that content may additionally or alternatively be requested from and generated and controlled by server 116, for example, in the event that server 116 stores playable content on behalf of the manager of the environment 200.

The pairing between the user device 108 and the TV 104 and STB 112 may be terminated in response to one or more triggers, such as the user device 108 leaving the premises (e.g., the room with the TV/STB or the overall environment 200), a user of the user device 108 checking out of their room (e.g., in a hotel), expiration of a timer tied to a timeout condition where the STB 112 does not receive any messages from the user device 108 within a certain time period, expiration of a timer not tied to a timeout condition (e.g., the pairing is terminated after three hours regardless of message activity), a command input by the user to the user device 108 to terminate the pairing, closing of the application or webpage on the user device 108 that is facilitating control of the STB/TV, and/or the like. In some examples, the pairing is terminated by deleting the IP address or other identifier of the user device 108 from the whitelist stored at the STB 112. Such deletion may be implemented by the STB 112 on its own or in response to a message from the server 116 containing instruction to remove the user device 108 from the whitelist.

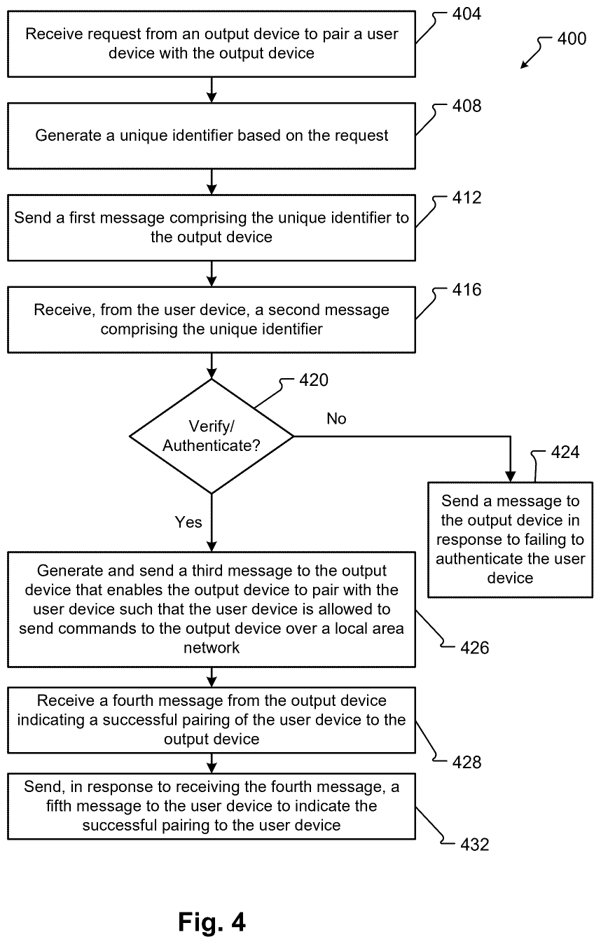

FIG. 4 illustrates a method 400 according to at least one example embodiment. The method 400 may be performed by a server 116 or by another element having the same or similar functionality. In more detail, the method 400 relates to a method for direct pairing between an output device 102 and a user device 108 under supervision of a managing entity, such as server 116, with the method 400 enabling the user device 108 to control the output device 102 with local communications (e.g., over a LAN). Each step or operation in method 400 may be carried out with one or more suitable messages or signals sent over a wired and/or wireless connection by one or more elements of the system 100, such as shown and described with reference to FIG. 3.

In step 404, the method 400 includes receiving a request from an output device 102 to pair a user device 108 with the output device 102. Step 404 may be performed in the same or similar manner as steps 302 and 304 from FIG. 3. As described above, in some examples, the request to pair the user device 108 with the output device 102 is based on user input to the output device 102. As described herein, the output device 102 may comprise a display 104 and an endpoint device 112, such as an STB or built-in client (i.e., IP client) of the display 104, that stores an identifier (e.g., unique identifier) of the user device 108 in a whitelist upon successful pairing. The user input to the output device 102 may include user selection, through a remote control of the output device 102, of an option displayed on a display 104 of the output device 102 to pair the user device 108 with the output device 102 (e.g., with an the STB 112 or built-in client of display 104).

Step 408 includes generating a unique identifier based on the request from step 404 and may be performed in the same or similar manner as step 306. For example, step 408 occurs in response to receiving the request from step 404. In some examples, the unique identifier comprises randomly generated code, such as a randomly generated scan code (e.g., QR code, bar code, etc.) scannable by a camera of the user device 108. In some examples, the randomly generated code is a series of characters, such as a random six digit number. The unique identifier may be generated by a random number generator or pseudo random number generator of the server 116. The unique identifier may be generated for each request received in step 404.

Step 412 includes sending a first message comprising the unique identifier to the output device 102, such as described with reference to step 308 of FIG. 3. If the server 116 is remote to the environment 200, then the first message may traverse both a WAN (Net2) and a LAN (Net1). If the server 116 is local to the environment 200, then the first message may traverse only the LAN. The output device 102 may receive and display the unique identifier on the display 104 for viewing and/or scanning by a user of user device 108 in accordance with step 310 in FIG. 3.

Step 416 includes receiving, from the user device 108, a second message comprising the unique identifier. For example, the user of the user device 108 scans the scannable code with a camera of the user device 108 or manually enters characters of the unique identifier in accordance with step 311 of FIG. 3. Thereafter, in accordance with step 312 of FIG. 3, the user causes the user device 108 to send a message to the server 116 with the unique identifier and, in some examples, user-specific information and/or other information that enables the server 116 to authenticate the user device 108 as a device that should be allowed to control the output device 102 (see step 314). Stated another way, the second message may comprise authentication information associated with the user device 108, which may include the unique identifier and user-specific information. Prior to or in conjunction with step 416, the user device 108 may be wirelessly connected to an SSID of the environment 200 (e.g., an SSID set by the router 120 or a similar connection (e.g., BLUETOOTH) involving the endpoint device 112) so as to enable the user device 108 to send the second message to the server 116. Alternatively,

Step 420 includes determining whether the user device 108 is verified and/or authenticated as a user device that is authorized to control the output device 102. For example, the server 116 may compare information received in the second message (unique identifier, user-specific information, etc.) to stored information, such as the unique identifier as sent in step 412 and user-specific information (e.g., guest name, loyalty number, room number, phone number of user device 108, IP address of user device 108, and/or the like), to verify and/or authenticate the user device 108 as one that should be allowed to control the output device 102.

If the user device 108 fails verification or fails authentication in step 420, the method 400 proceeds to step 424 where the server sends a message to the output device 102. Step 424 may occur in response to failing to authenticate the user device 108 in step 420. In some examples, step 424 causing the display 104 of the output device 102 to display an indication of the failed authentication to inform the user that their user device 108 is not yet authorized to send commands to the output device 102. The indication of the failed verification or authentication may include one or more reasons as to why the verification or authentication failed, such as an indication as to why the user has been denied access over controlling the output device 102 (e.g., connection lost, account suspended, timeout condition reached, etc.). The method 400 may end after step 424 and/or the above-mentioned indication may instruct the user to retry pairing by returning to step 404.

If the user device 108 is verified or authenticated in step 420, the method 400 proceeds to step 426. Step 426 includes generating and sending a third message to the output device 102 that enables the output device 102 to pair with the user device 108 such that the user device 108 is allowed to send commands to the output device 102 over the LAN (Net1). In some examples, step 426 occurs in response to verifying and/or authenticating the user device 108 in step 420. In accordance with step 316 of FIG. 3, step 426 may send a whitelist message to the output device 102 with the whitelist message including information that specifically identifies the user device 108. The information that identifies the user device 108 may be stored at the output device 102 and include an IP address of the user device 108, a phone number of the user device 108, or some other identifier (e.g., unique identifier) that enables the output device 102 to verify the pairing with the user device 108 so that commands received from the user device 108 are used to control various aspects of the output device 102, such as channel, volume, menu selection, display settings, etc.

Step 428 may include receiving a fourth message from the output device 102 indicating a successful pairing of the user device 108 to the output device 102. For example, the output device 102 may send the fourth message to the server 116 in response to the output device 102 successfully storing the information that identifies the user device 108. In other examples, the output device 102 sends the fourth message in response to the output device 102 successfully executing a test command received from the user device 108.

In response to the server 116 receiving the fourth message, the method may execute step 432 to send a fifth message from the server 116 to the user device 108 to indicate the successful pairing to the user device 108, thereby notifying the user that the user device 108 is ready to send commands to the output device 102.

Here, it should be appreciated that steps 428 and 432 may be optional and that, in general, upon completion of step 426 (though in some cases upon completion of step 432), the output device 102 and the user device 108 are paired with one another, thus enabling commands and/or response messages to travel between the user device 108 and the output device 102 in accordance with step 328 of FIG. 3. Commands from the user device 108 may be sent directly to the output device 102 via a wireless connection (e.g., infrared signals). Alternatively, commands from the user device 108 travel to the output device 102 through one or more elements of the LAN, such as the router 120 and/or a switch 124.

In some examples, the output device 102 (e.g., the endpoint device 112 or an IP client of display 104) is configured to run a content application of the content server 132 that provides content (e.g., subscription streaming content) to the output device 102. In this example, the third message in step 426 additionally or alternatively enables the user device 108 to control the content application running on the output device 102. Controlling the content application may include navigating menus and selecting content for streaming to the output device 102. In other examples, the user device 108 and the output device 102 have casting functions and the method 400 carries out casting in accordance with steps 332 and 336.

Although not explicitly shown, it should be appreciated that the method 400 may further comprise one or more steps that unpair the user device 108 and the output device 102. For example, the method 400 may include the server 116 sending a message to the output device that unpairs the user device and the output device in response to a trigger, such as the user device 108 leaving the premises (e.g., the room with the TV/STB or the overall environment 200), a user of the user device 108 checking out of their room (e.g., in a hotel), expiration of a timer tied to a timeout condition where the output device 102 does not receive any messages from the user device 108 within a certain time period, expiration of a timer not tied to a timeout condition (e.g., the pairing is terminated after three hours regardless of message activity), a command input by the user to the user device 108 to terminate the pairing, closing of the application or webpage on the user device 108 that is facilitating control of the STB/TV, and/or the like.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), graphics processing units (e.g., Nvidia Geforce RTX 2000-series processors, Nvidia Geforce RTX 3000-series processors, AMD Radeon RX 5000-series processors, AMD Radeon RX 6000-series processors, or any other graphics processing units), application specific integrated circuits (ASICs), field programmable gate arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

### Example Embodiments May be Configured as Follows:

(1) A system, comprising:
   a server configured to:
      generate a unique identifier based on a request from an output device to pair a user device with the output device;
      send a first message comprising the unique identifier to the output device;
      receive, from the user device, a second message comprising the unique identifier; and
      generate and send a third message to the output device that enables the output device to pair with the user device such that the user device is enabled to control the output device over a local area network.
(2) The system of (1), wherein the request to pair the user device with the output device is based on user input to the output device.
(3) The system of one or more of (1) to (2), wherein the user input to the output device includes selection of an option displayed on a display of the output device to pair the user device with the output device.
(4) The system of one or more of (1) to (3), wherein the unique identifier comprises randomly generated code.
(5) The system of one or more of (1) to (4), wherein the randomly generated code is scannable by a camera of the user device.
(6) The system one or more of (1) to (5), wherein the randomly generated code is a series of characters.
(7) The system of one or more of (1) to (6), further comprising:
   the output device, wherein the output device comprises:
      a display; and
      an endpoint device configured to store an identifier of the user device in a whitelist.
(8) The system of one or more of (1) to (7), wherein the output device is configured to run a content application of a content server that provides content to the output device, wherein the third message enables the user device to control the content application.
(9) The system of one or more of (1) to (8), further comprising:
   the content server.
(10) The system of one or more of (1) to (9), wherein the second message comprises authentication information associated with the user device, and wherein the server is configured to authenticate the user device based on the authentication information.
(11) The system of one or more of (1) to (10), wherein the server is configured to send the third message in response to authenticating the user device.
(12) The system of one or more of (1) to (11), wherein the server is configured to send a fourth message to the output device in response to failing to authenticate the user device.
(13) The system of one or more of (1) to (12), wherein the fourth message causes a display of the output device to display an indication of the failed authentication.
(14) The system of one or more of (1) to (13), further comprising:
   an edge device configured to control traffic between the local area network that comprises the output device and a wide area network that comprises the server.
(15) The system of one or more of (1) to (14), wherein the local area network is managed by a first entity, and wherein the wide area network cannot be managed by the first entity.
(16) The system of one or more of (1) to (15), wherein the server is configured to:
   receive a fourth message from the output device indicating a successful pairing of the user device to the output device; and
   send, in response to receiving the fourth message, a fifth message to the user device to indicate the successful pairing to the user device.
(17) A device, comprising:
   a processor; and
   memory including instructions that when executed by the processor, cause the processor to:
      generate a unique identifier based on a request from an output device to pair a user device with the output device;
      send a first message comprising the unique identifier to the output device;
      receive, from the user device, a second message comprising the unique identifier; and
      generate and send a third message to the output device that enables the output device to pair with the user device to allow the user device to control the output device over a local area network.
(18) The device of (17), wherein the third message comprises an identifier of the user device that is stored at the output device.
(19) The device of one or more of (17) to (19), wherein the instructions include instructions that when executed by the processor, cause the processor to send a fourth message to the output device that unpairs the user device and the output device to disable control of the output device by the user device.
(20) A method, comprising:
   generating a unique identifier based on a request from an output device to pair a user device with the output device;
   sending a first message comprising the unique identifier to the output device;
   receiving, from the user device, a second message comprising the unique identifier; and
   generating and send a third message to the output device that enables the output device to pair with the user device to allow the user device to control the output device over a local area network.

It is claimed:

1. A system, comprising:
a server configured to:
generate a unique identifier based on a request from an output device to pair a user device with the output device;
send a first message comprising the unique identifier to the output device;
receive, from the user device, a second message comprising the unique identifier; and
generate and send a third message to the output device that enables the output device to pair with the user device such that the user device is enabled to control the output device over a local area network.

2. The system of claim 1, wherein the request to pair the user device with the output device is based on user input to the output device.

3. The system of claim 2, wherein the user input to the output device includes selection of an option displayed on a display of the output device to pair the user device with the output device.

4. The system of claim 1, wherein the unique identifier comprises randomly generated code.

5. The system of claim 4, wherein the randomly generated code is scannable by a camera of the user device.

6. The system of claim 4, wherein the randomly generated code is a series of characters.

7. The system of claim 1, further comprising:
the output device, wherein the output device comprises:
a display; and
an endpoint device configured to store an identifier of the user device in a whitelist.

8. The system of claim 1, wherein the output device is configured to run a content application of a content server that provides content to the output device, wherein the third message enables the user device to control the content application.

9. The system of claim 8, further comprising:
the content server.

10. The system of claim 1, wherein the second message comprises authentication information associated with the user device, and wherein the server is configured to authenticate the user device based on the authentication information.

11. The system of claim 10, wherein the server is configured to send the third message in response to authenticating the user device.

12. The system of claim 11, wherein the server is configured to send a fourth message to the output device in response to failing to authenticate the user device.

13. The system of claim 12, wherein the fourth message causes a display of the output device to display an indication of the failed authentication.

14. The system of claim 1, further comprising:
an edge device configured to control traffic between the local area network that comprises the output device and a wide area network that comprises the server.

15. The system of claim 14, wherein the local area network is managed by a first entity, and wherein the wide area network cannot be managed by the first entity.

16. The system of claim 1, wherein the server is configured to:
receive a fourth message from the output device indicating a successful pairing of the user device to the output device; and
send, in response to receiving the fourth message, a fifth message to the user device to indicate the successful pairing to the user device.

17. A device, comprising:
a processor; and
memory including instructions that when executed by the processor, cause the processor to:
generate a unique identifier based on a request from an output device to pair a user device with the output device;
send a first message comprising the unique identifier to the output device;
receive, from the user device, a second message comprising the unique identifier; and
generate and send a third message to the output device that enables the output device to pair with the user device to allow the user device to control the output device over a local area network.

18. The device of claim 17, wherein the third message comprises an identifier of the user device that is stored at the output device.

19. The device of claim 17, wherein the instructions include instructions that when executed by the processor, cause the processor to send a fourth message to the output device that unpairs the user device and the output device to disable control of the output device by the user device.

20. A method, comprising:
generating a unique identifier based on a request from an output device to pair a user device with the output device;
sending a first message comprising the unique identifier to the output device;
receiving, from the user device, a second message comprising the unique identifier; and
generating and send a third message to the output device that enables the output device to pair with the user device to allow the user device to control the output device over a local area network.
